(19) United States
(12) Patent Application Publication
(10) Pub. No.: US 2017/0270820 A1
(43) Pub. Date: Sep. 21, 2017

(54) Eating Feedback System

(71) Applicant: ICON Health & Fitness, Inc., Logan, UT (US)

(72) Inventor: Darren C. Ashby, Richmond, UT (US)

(21) Appl. No.: 15/460,059

(22) Filed: Mar. 15, 2017

Related U.S. Application Data
(60) Provisional application No. 62/310,527, filed on Mar. 18, 2016.

(51) Int. Cl. G09B 19/00; G09B 5/06; G09B 5/04; G06F 1/16; G09B 5/02

(52) U.S. Cl. CPC G09B 19/0092; G06F 1/163; G09B 5/02; G09B 5/04; G09B 5/06

(57) ABSTRACT

An eating feedback system includes a wearable, a sensor connected to the wearable, a memory, and processor. The memory includes programmed instructions to cause the processor to count a chew number executed by a user based on measurements recorded with the sensor and communicate feedback to the user based on the chew number.

### RELATED APPLICATIONS

This application claims priority to U.S. Patent Application Ser. No. 62/310,527 titled “Eating Feedback System” and filed on Mar. 18, 2016, which application is herein incorporated by reference for all that it discloses.

### BACKGROUND

Those trying to lose weight often track the number of calories that they consume during a day. The goal is to consume less calories than calories that are burned through exercise and daily body maintenance. Having a deficit of calories in a day is linked to weight loss. On the other hand, body builders and some athletes desire to gain muscle. Thus, they try to eat more calories than they burn during a day. The excess calories are believed to contribute to muscle gain when an individual executes appropriate workouts.

To track the number of calories eaten in a day, a user often looks at labels on food packaging and determines the amount of the food that he or she will eat. If no calorie information is listed on the food packaging, the user may search the internet or look at publications to determine or estimate the amount of calories in the food that he or she is eating.

One type of system for tracking the amount of calories in a user's food is disclosed in U.S. Patent Publication No. 2013/0273506 issued to Stephanie Melowsky. In this reference, a system and method for collecting food intake related information includes processing the information into a caloric value, recording, and reporting the value. The system includes an electronic device having a sensor, an input device, a display, processor, memory, and code modules executing in the processor for implementation of the method. Information concerning the swallowing of food is collected. Weighting factors related to the caloric concentration of the food being ingested are also collected. The caloric value of the users eating is computed by the processor by combining the swallow data with weighted parameters in accordance with an algorithm. The caloric value is recorded in a user's profile and notifications can be generated based on the caloric value and a historical record of food intake information can be maintained and provided to the user via a portal such as a smart phone device or the internet. Another type of system is described in U.S. Patent Publication No. 2011/0276312 issued to Tadmor Shalon, et al.

### SUMMARY

In one embodiment, an eating feedback system includes a wearable, a sensor connected to the wearable, a memory, and processor. The memory includes programmed instructions to cause the processor to count a chew number executed by a user based on measurements recorded with the sensor and communicate feedback to the user based on the chew number.

The eating feedback system may include a command to execute additional chews.

Communicating feedback to the user based on the chew number may occur when the chew number falls below a predetermined chew threshold.

The eating feedback system may further include a speaker where communicating the feedback includes generating an audible command with the speaker.

The wearable may include a hat.

The wearable may include eye ware.

The wearable may include neck apparel.

The sensor may include a microphone.

The sensor may come into mechanical contact with a jaw of a user when the wearable is worn by the user while the user is chewing.

The programmed instructions may further cause the processor to determine a bite number based on at least one chewing attribute.

The programmed instructions may further cause the processor to determine a calorie number based on the bite number.

The programmed instructions may further cause the processor to determine an eating rate based on the at least one chewing attribute.

The programmed instructions may further cause the processor to generate a message to the user based on the eating rate.

The sensor may include an audio detection component that detects vocalization of the user, wherein the sensor stops incrementing counts when detecting a vocalization of the user.

The system may further include an activation component that, when activated, causes the programmed instructions to initiate counting.

The sensor may be in communication with a remote device, and the sensor may send recorded chewing data to the remote device.

In one embodiment, an eating feedback system includes a wearable, a sensor connected to the wearable, a memory, and processor. The memory includes programmed instructions to cause the processor to detect at least one chewing attribute based on measurements recorded with the sensor and determine a bite number based on the at least one chewing attribute.

The programmed instructions may further cause the processor to determine a calorie number based on the bite number.

The programmed instructions may further cause the processor to determine an eating rate based on the at least one chewing attribute.

The programmed instructions may further cause the processor to generate a message to the user based on the eating rate.

The programmed instructions may further cause the processor to count a chew number executed by a user based on measurements recorded with the sensor and communicate feedback to the user based on the chew number.

The feedback may include a command to execute additional chews.

In one embodiment, a wearable device includes an attachment feature, a sensor connected to the attachment feature, a memory, and processor. The memory includes programmed instructions to cause the processor to count a chew number executed by a user based on measurements recorded with the sensor, communicate feedback to the user based on the chew number, determine a bite number based on at least one chewing attribute, determine a calorie number based on the bite number, determine an eating rate based on the at least one chewing attribute, and generate a message to the user based on the eating rate.

### BRIEF DESCRIPTION OF THE DRAWINGS

The accompanying drawings illustrate various embodiments of the present apparatus and are a part of the specification. The illustrated embodiments are merely examples of the present apparatus and do not limit the scope thereof.

FIG. 1 illustrates a perspective view of an example of an eating feedback system in accordance with the present disclosure.

FIG. 2 illustrates a block diagram of an example of an eating feedback system in accordance with the present disclosure.

FIG. 3 illustrates an example of a mobile device in communication with sensors for tracking an amount of calories consumed in accordance with the present disclosure.

FIG. 4 illustrates an example of a mobile device in communication with sensors for tracking an amount of calories consumed in accordance with the present disclosure.

FIG. 5 illustrates an example of a mobile device in communication with sensors for tracking an amount of calories consumed in accordance with the present disclosure.

FIG. 6 illustrates a perspective view of an example of an eating feedback system in accordance with the present disclosure.

FIG. 7 illustrates a perspective view of an example of an eating feedback system in accordance with the present disclosure.

Throughout the drawings, identical reference numbers designate similar, but not necessarily identical, elements.

### DETAILED DESCRIPTION

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Further, for purposes of this disclosure, the term “mechanical communication” generally refers to components being in direct physical contact with each other or being in indirect physical contact with each other where movement of one component affects the position of the other.

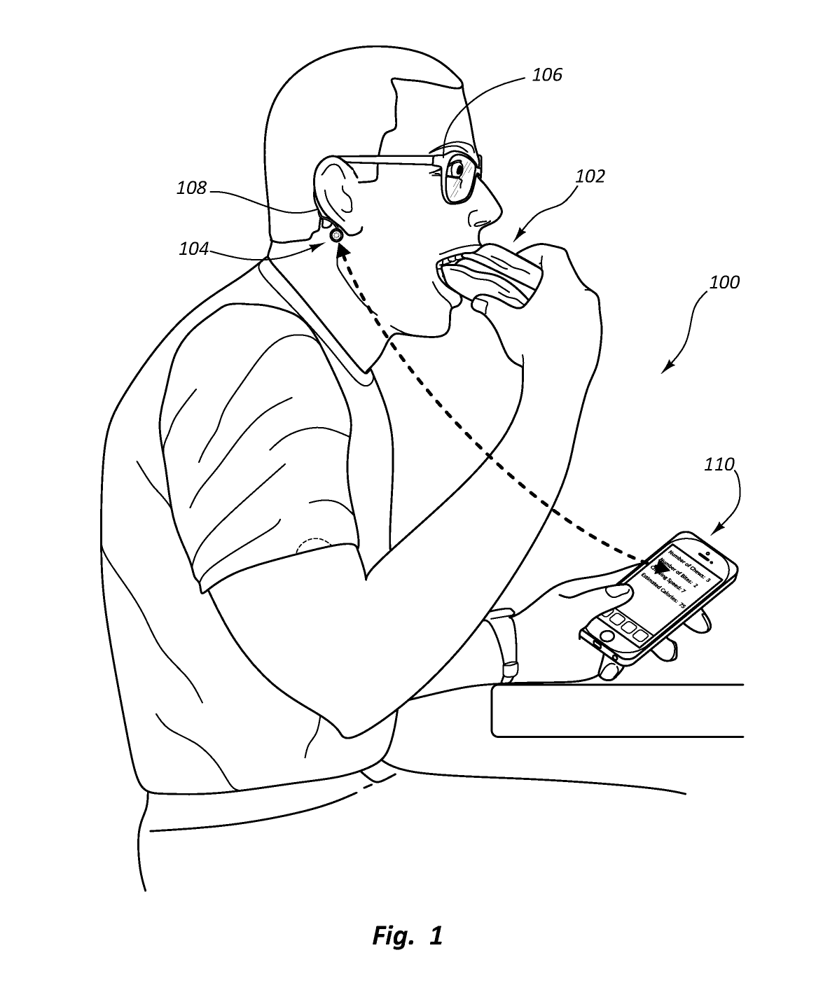

Particularly, with reference to the figures, FIG. 1 illustrates a perspective view of an example of a tracking system 100 for tracking a consumed amount of calories. In this example, a user is consuming food 102. As the user eats, a sensor 104 attached to the user's eye wear 106 picks up swallowing and/or chewing sounds/motions, which help to determine details about how and what the user is eating. The sensor 104 may be attached to an attachment feature, such as the earpiece 108 of the user's eye wear 106. The sensor 104 may send a measured output to a mobile device 110 carried by the user.

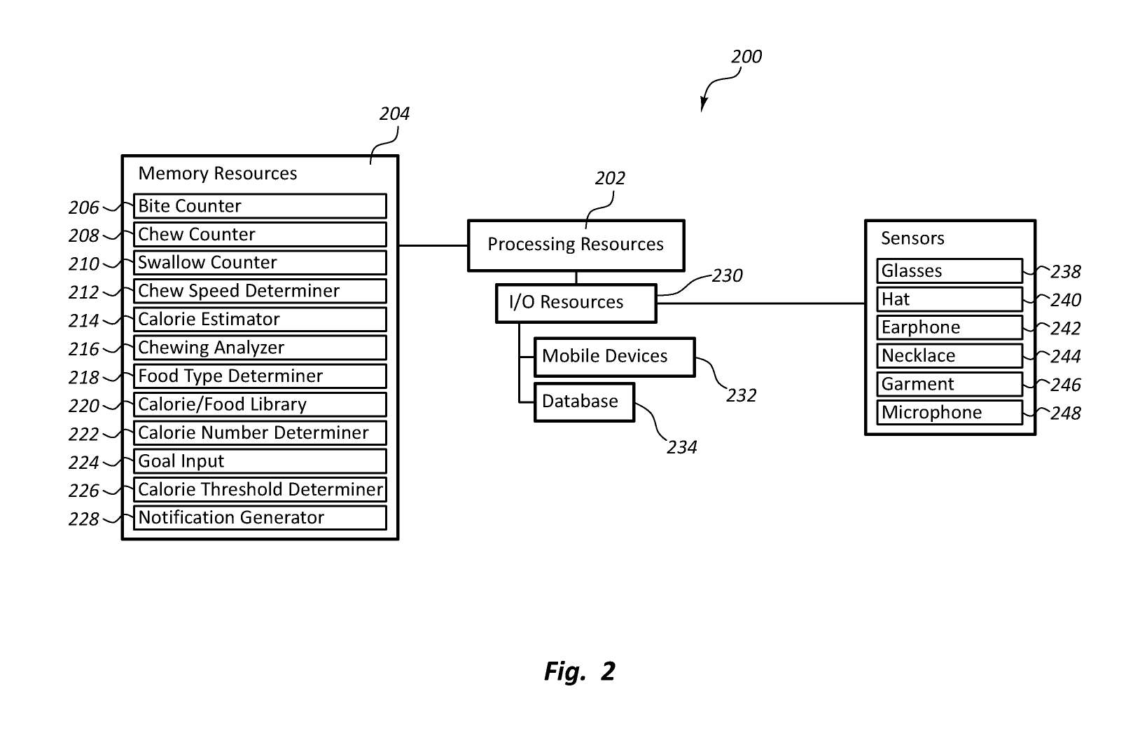

FIG. 2 depicts an example of a tracking system 200. In this example, the tracking system 200 includes processing resources 202 and memory resources 204. The memory resources 204 may cause the processing resources 202 to carry out functions programmed in the memory resources 204. In this example, the memory resources 204 include a bite counter 206, a chew counter 208, a swallow counter 210, a chew speed determiner 212, a calorie estimator 214, a chewing analyzer 216, a food type determiner 218, a calorie/food library 220, a calorie number determiner 222, a goal input 224, a calorie threshold determiner 226, and a notification generator 228.

The processing resources 202 may be in communication with I/O resources 230, which may include a receiver, a transmitter, a transceiver, another type of communication device, or combinations thereof. The I/O resources 230 may be in communication with a mobile device 232, a database 234, another type of device, or combinations thereof. Further, the processing resources 202 may be in communication with the user's glasses 238, hat 240, earphone 242, necklace 244, garment 246, microphone 248, another type of device, or combinations thereof.

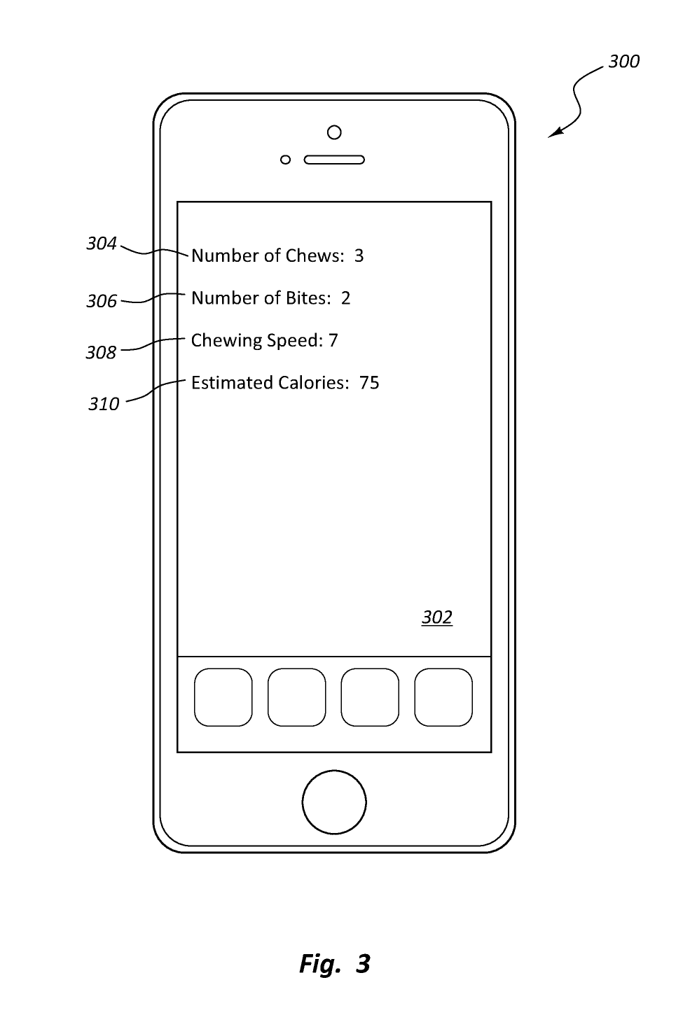

FIG. 3 depicts an example of mobile device 300. In this example, the mobile device 300 includes a display 302 that presents information details about what and how the user is eating. In this example, the mobile device 300 depicts a chew number 304, a bite number 306, a chewing speed 308, and a calorie estimate 310.

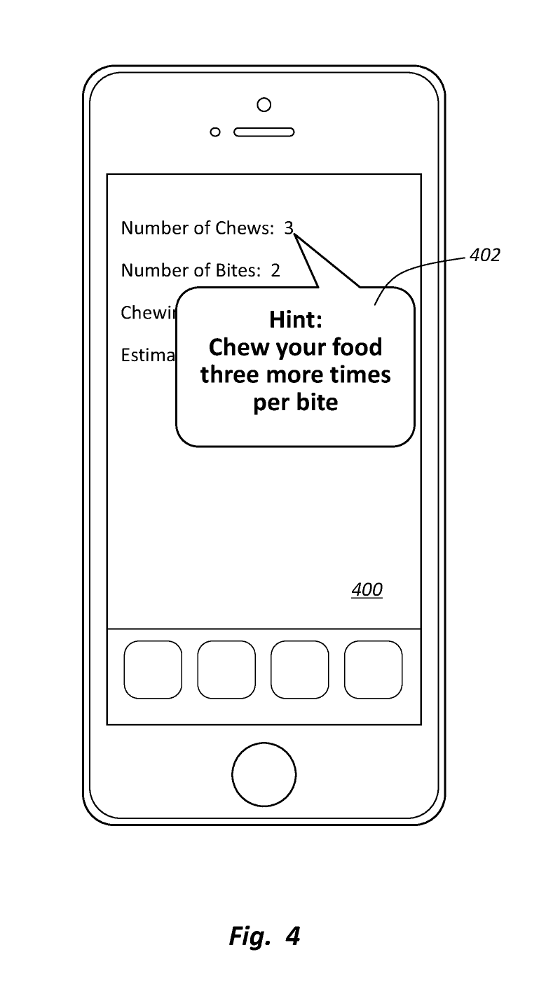

FIG. 4 depicts an example of the mobile device's display 400. In this example, a notification 402 is presented in the display 400 that indicates that the user should chew his or her food more.

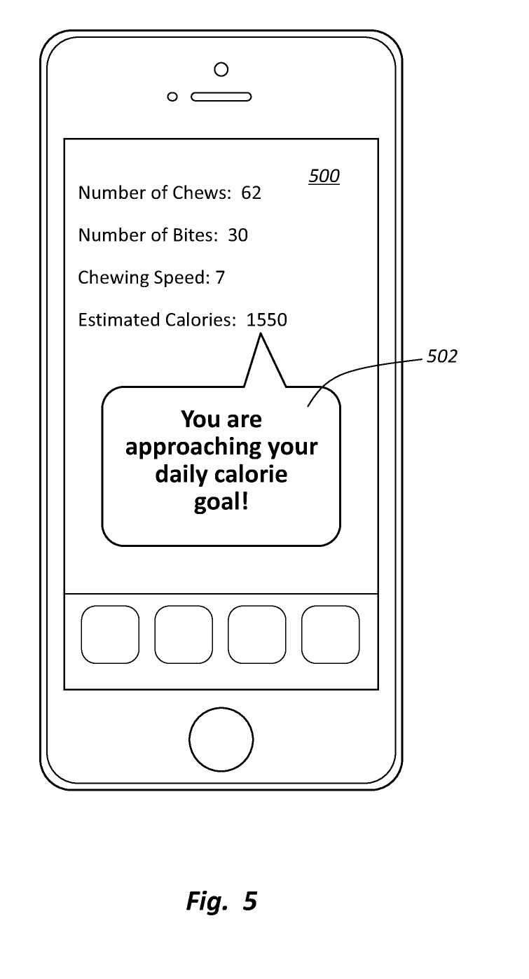

FIG. 5 depicts an example of the mobile device's display 500. In this example, a notification 502 is presented in the display 500 that indicates that the user is approaching his or her daily calorie goal.

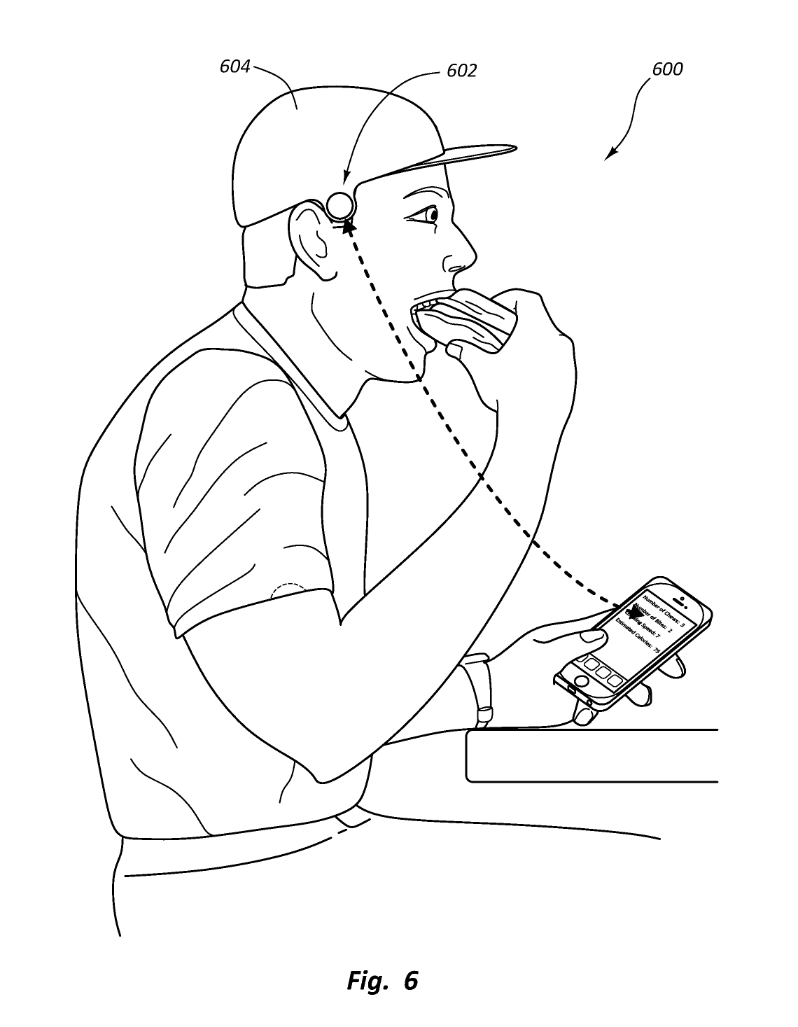

FIG. 6 depicts an example of a tracking system 600. In this example, the system includes a hat 604. The hat 604 may include an accelerometer 602 that is placed proximate to the user's temples so that when the user chews, the movement of the user's temples are detected. As a result, the accelerometer can provide an output that reflects the number of chews performed by the user. In other examples, the hat 604 may include a band with a portion that is proximate the user's temples. The band may also include a strain gauge. As the user chews, the temples apply a load to the hat's band that can be detected by the strain gauge. As a result, the strain gauge can detect when the user chews. Any appropriate sensor may be incorporated into a hat to detect when the user chews.

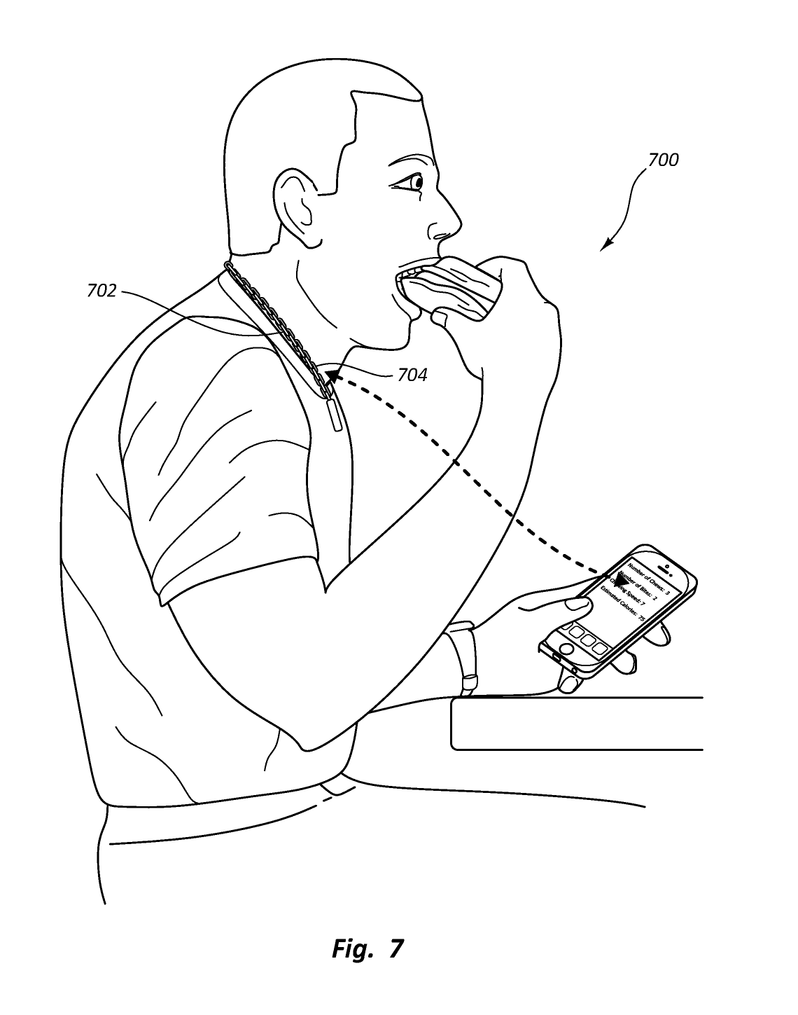

FIG. 7 depicts another example of a tracking system 700. In this example, the tracking system 700 includes neck apparel 702 that includes a sensor 704 positioned to detect the chewing performed by the user. For example, in some cases, the neck apparel 702 includes an accelerometer that detects movement resulting from the chewing motions of the user. In other examples, the accelerometer may come into contact with the user's chin when the user chews. In yet another example, the necklace 702 may include a microphone that detects sounds produced from the user chewing.

### GENERAL DESCRIPTION OF THE INVENTION

In general, the invention disclosed herein may provide a user with a convenient system for receiving feedback on how he or she is eating. Many individuals are unaware of how much they eat and/or unaware that their eating habits affect how much they eat. The principles described herein provide significant improvements to the eating industry by providing feedback to users as they eat that enables the users to form better eating habits. The principles herein may be incorporated into consumer end products that an individual can use throughout his or her day. In other examples, the invention may be utilized by a healthcare professional to educate clients trying to form healthier eating habits. Further, the principles described herein may be employed at restaurants, resorts, travel destinations, or other locations.

The invention may include a wearable that includes a sensor. The sensor may be placed near the user's jaw or another body part that moves or produces a noise as the user eats. The data collected by the sensor can be processed to provide the user with information that the user can use to adjust the way he or she eats. In one situation, the user may feel fuller sooner if the user chews his food longer. In that circumstance, the sensor or a device that receives the data from the sensor may send instructions to the user to chew his or her food more. In another example, a consistent number of calories may be estimated per bit of food. In this situation, the tracking system may track an estimated number of calories consumed by the user. In this case, the tracking system may send instructions to the user that the user is approaching his or her calorie goal for the day or is likely to fall short of his or her calorie goals for the day. Other details that may be ascertained from the data collected by the user may include the rate at which the user is eating. The tracking system may indicate to the user that he or she ought to speed up or slow down his or her eating rate. In some cases, the tracking system merely presents information to the user, but does not provide instructions or suggestions to the user about how to change how the user is eating.

The instructions may be sent to the user through any appropriate mechanism. For example, the system may incorporate a mobile device that processes the data collected by the sensor and present the information and/or suggestions to the user. In one examples, the information and/or suggestions are presented to the user in the display of the mobile device. In other examples, the information or suggestions are presented to the user through a speaker that provides an audible message to the user. In yet other examples, the information is sent to the user through an electronic message (e.g. text message, email, instant messaging, calendar event, etc.).

The sensor may be attached to any appropriate feature of the wearable that positions the sensor to detect the user's chewing. In one example, the wearable's feature is the earpiece of the user's glasses. In other examples, the wearable may include jewelry, necklace, earrings, hats, earphones, garments, clothing, hats, scarfs, other types of features, or combinations thereof and the sensor may be attached to these wearables in any appropriate manner to position the sensor to detect chewing.

In examples where the sensor is a microphone and attached to the earpiece of the user's glasses, the microphone may detect sounds from the user chewing. The bones of the user's face, such as the jawbone and other bones, may conduct low frequency sound waves. The patterns from these sounds may indicate the number of times that the user chewed his or her food per mouthful of food. For example, each distinct sound pattern that represents a single chew may be added together to determine a number of chews. Gaps between those sound patterns that represent a chew may indicate that the user has swallowed the food in his or her mouth. Thus, the number of chews per bite of food and the number of swallows may be used to determine the eating rate of the user and the number of chews executed by the user.

In some cases, the tracking system may have a chewing threshold that is determined to be an optimal number of chews that the user should execute per bite or for an entire meal. This threshold number may be based on an understanding that a user feels full sooner when the user chews more. Accordingly, the user may feel more satisfied by eating less if the user chews his or her food more. In some cases, the tracking system may include a value that is determined to be an optimal number of chews per bite of food. In those circumstances where the number of chews executed by the user falls short of that predetermined number of chews, the tracking system may send the user instructions to chew his or her food more. These instructions may include a general statement that the user should chew more. Alternatively, the instructions may include specific recommendations, like the user should chew his food three more times, or another amount of times more per bite of food.

The tracking system may determine the number of calories that the user is consuming during a meal by counting the number of swallows. The tracking system may have an assumption that each bite of food has a predetermined average number of calories (e.g. 25 to 30 calories per bite). In this example, the tracking system may multiply the swallow number by the predetermined average number of calories per bite to arrive at a current calorie amount of the user. The tracking system may update the user about his or her progress towards a calorie goal based on the number of calories that the user is having per meal, per day, or week, per another time period, or combinations thereof.

In alternative examples, the estimated number of calorie consumed by the user and determined by the system may be refined based on other types of data collected with the sensor. For example, the amount of time that food is chewed may reveal characteristics about the food, such as the amount of food, the type of food, the consistency of food, other types of food characteristics, or combinations thereof. In some examples, the sensor records the amount of time that the user chews an amount of food. The duration of time may be used to determine the volume of food. In other examples, the types of sounds generated during chewing may be used to determine the volume of food. For example, frequency patterns that represent liquid food, soft food, brittle food, chewy food, or other types of food characteristics may be used as a factor to determine the amount and/or type of food. In one example, if sounds are detected that indicate that the food has a chewy consistency, the calculated amount of food may be adjusted downward to reflect that the type of food may need more chews than other types of food. In the same example, soft food may be broken down from chewing with relatively less chewing than the food with the chewy consistency. As a result, detected food types may be associated with chew to volume ratios to more accurately determine the volume of food consumed by the user.

While the examples above have been described in relations to determining the number of calories that the user consumes, the same principles may be employed to determine other types of nutritional information being consumed by the user. In those examples where a type of food is identified, the tracking system may also estimate amounts of fiber, salt, protein, carbohydrates, vitamins, minerals, water, and other types of nutritional information based on the number of chews and/or swallows executed by the user.

The number of swallows may be recorded with a microphone of the sensor. Thus, sounds that are generated through swallowing may be detected during each swallow and may be recorded. In other examples, time periods between chewing activity may also counted as swallows. For example, if chewing activity is detected and the chewing activity stops for a time before the chewing activity resumes, the pauses in chewing activity may be counted as a swallow. In circumstances where the sensor detects just chewing sounds, the pauses in chewing activity may represent the time that swallowing occurs or may represent that a new batch of food has replaced a previous volume of food in the mouth.

The sensor may include an accelerometer. The accelerometer may detect movements that represent chewing and/or swallowing. For example, during chewing, an accelerometer in contact with the user's jaw may detect the jaw's movement. But, the amount of tension on the user's skin may also alternate between higher and lower amounts of tension as the jawbone moves. The varying amounts of tension may cause the skin around the ears, neck, throat, jaw and other locations of the user's head to move during chewing. The accelerometer may be positioned to detect any of these movements. Further, the user's muscles may flex and relax during chewing, and this muscle movement may also be detected by the accelerometer.

In some examples, just chewing is detected with a microphone. In other examples, just swallowing is detected with a microphone. In other examples, the sensor includes just a microphone to detect both chewing and swallowing. In other examples, just chewing is detected with an accelerometer. In yet other examples, just swallowing is detected with an accelerometer. In further examples, the sensor includes just an accelerometer to detect both chewing and swallowing.

The sensor may have a processor and logic to interpret the recorded sounds and/or movements. In other situations, the sensor may send the recordings to another device to interpret the recordings. In some examples, the sensor may process at least a portion of the recordings to be sent to the mobile device to reduce bandwidth. In these examples, the sensor may compress data, filter data, or otherwise modify the data. In other examples, the sensors may include minimal logic to reduce the amount of power needed to operate the sensor. In some cases, a battery may be fixed to the eye wear or other device holding the sensor. In other cases, the battery is incorporated directly into the sensor. Further, the sensor may be powered with energy harvested from its environment by converting movement and/or heat of the user into useable energy.

In some situations, the sensor is calibrated to be specific to the user. For example, mouth sizes varies from person to person and the sensor may be calibrated to the user's mouth size. In this type of example, the chewing sensors may be calibrated based on the amount of fluid that the user can retain in his or her mouth and squirt into a measuring cup. But, other mechanisms for determining the user's mouth size may be used in accordance with the principles described in the present disclosure.

In some cases, the system includes a sensor that has an audio detection component. This component may recognize chewing and swallowing sounds that indicate that the user is eating. This audio detection component may also recognize other sounds that indicate that the user is not eating. For example, the audio detection component may determine that the user is talking. In this situation, the system may stop counting sounds that are recognized as chewing and/or swallowing. In some examples, the audio detection component may include a directional aspect that indicates the direction that sounds are coming from. With this feature, the system may determine if the speaking sounds are coming from the user or whether they are coming from a different individual. In this example, the system stops the chew/swallow count only for those speaking sounds that come from a direction of the user. Further, if the audio detection component detects chewing and swallowing sounds that come from a different person, the system can determine which sounds merit a count for the user and which chewing/swallowing sounds are coming from another person.

In some cases, the system has an option to turn the counting feature on or off. In these examples, the user can indicate when the user desires to have the system counting. This may avoid false positive readings when the user produces a sound similar to a chewing/swallowing sound that is not associated with eating. A false positive may occur when the user chews gum, drinks water, produces certain sounds during a conversation, other situations, or combinations thereof.

The system may be in communication with a mobile device, a hand-held device, a networked device, another type of remote device, or combinations thereof. The sensor, in conjunction with the handheld device, may record the number and frequency of chews and analyze that pattern for one consistent with consuming food. When an appropriate pattern is recognized, the other device in communication when the sensor may, when detected, calculate the corresponding eating parameters. This may build up a personalized history that can be used to more precisely identify unique sounds associated with the user's eating that are specific to the user, providing increased accuracy to the system. Further, the analysis may also provide statistics of the user's eating patterns and behaviors. Based on this analyzed information, the user can make changes to his or her eating habits to improve appropriate areas.

In other examples, the tracking system includes a hat and holds the sensor proximate to the user's temples. As the user chews, the temples flex outward causing the circumference of the user's head to expand. A strain gauge incorporated into the hat may detect the changes in the circumference of the user's head. These changes may be used to determine the number of chews executed by the user. In other examples, the hat may include an accelerometer that can detect movement generated by the temple's movement. In yet other examples, the hat may position a sensor against the user's skin that can determine tension changes in the user's skin resulting from the user chewing. Any of these mechanisms may be used to determine the number of chews and/or swallows executed by the user.

In yet another example, the sensor may be incorporated into a necklace or another type of device that positioned around the user's neck. The necklace's sensor may detect movement generated from chewing, sounds generated from chewing, skin tension changes generated from chewing, electrical properties generated from chewing, other types of properties generated from chewing, or combinations thereof.

In some cases, the user may input goals into the tracking system. In this example, the user may input his or her goals through the mobile device or another device in communication with mobile device. These goals may include calorie goals, other nutritional goals, or combinations thereof. Messages from the tracking system may keep the user updated on his or her progress towards reaching those goals. Notifications from the tracking system may include messages indicating that the user is approaching one of the threshold limits for a goal, that the user is at risk for choking based on the speed he or she is eating, that the user is consuming too many calories to be optimally digested in a single meal without converting the food to fat, and so forth.

The type of food may be identified by the user inputting the type of food into the mobile device. In some cases, the user inputs into the mobile device's keyboard or touch screen the food type. In other examples, the user can select an icon that represents the food type. Further, in some cases, the user can verbally speak the type of food to identify the food type. In an additional example, an image of the food is taken and analyzed to determine the food type. The camera that takes the image may be part of the mobile device, or the camera may be part of another device independent of the mobile device.

The calorie number, the volume of food, the type of food, other nutritional data, or combinations thereof may be sent to a remote database for storage. The remote storage may be accessible to the user over a network, such as the internet. The user may access the records of his or her eating history, determine eating patterns and habits and make adjustments. In some situations, this nutritional information may be stored in a database or be accessible to a user profile of an exercise program. An example of a user program that may be compatible with the principles described herein can be found at www.ifit.com, which is administered through Icon Health and Fitness, Inc. located in Logan, Utah, U.S.A. In some examples, this nutritional information may be made public at the user's request or be made viewable to certain people. These individuals may give the user advise about improving eating habits. In other examples, the user may compete with others to have lower amounts of calories within a time period or to achieve a different type of nutritional goal.

In some examples, a camera is attached to the user's eye wear so that the camera can capture an image of the food as the food approaches the user's mouth. The camera may be positioned at any appropriate location. For example, the camera may be worn by the user on his or her eye wear, a hat, a scarf, jewelry, a necklace, a wearable device, a shirt, a coat, another article of clothing, an adhesive, teeth braces, a bow tie, another device, or combinations thereof.

The camera may have a processor and logic to interpret the characteristics of the food to determine the food type. In other situations, the camera may send the images to another device to interpret the data. The camera may send at least a portion of the data to the mobile device for processing or to be relayed to another device for processing. In some cases, the data may be modified before being sent to a remote device. For example, the camera may compress data, filter data, or otherwise modify the data. In other examples, the camera includes minimal logic to reduce the amount of power needed to operate the camera.

The tracking system may include a combination of hardware and programmed instructions for executing the functions of the tracking system. The tracking system may include processing resources that are in communication with memory resources. Processing resources include at least one processor and other resources used to process the programmed instructions. As described herein, the memory resources may represent generally any memory capable of storing data such as programmed instructions or data structures used by the tracking system.

The processing resources may include I/O resources that are capable of being in communication with a remote device that stores the user information, eating history, workout history, external resources, databases, or combinations thereof. The remote device may be a mobile device, a cloud based device, a computing device, another type of device, or combinations thereof. In some examples, the system communicates with the remote device through a mobile device which relays communications between the tracking system and the remote device. In other examples, the mobile device has access to information about the user. The remote device may collect information about the user throughout the day, such as tracking calories, exercise, activity level, sleep, other types of information, or combination thereof.

The remote device may execute a program that can provide useful information to the tracking system. An example of a program that may be compatible with the principles described herein includes the iFit program which is available through www.ifit.com identified above. An example of a program that may be compatible with the principles described in this disclosure is described in U.S. Pat. No. 7,980,996 issued to Paul Hickman. U.S. Pat. No. 7,980,996 is herein incorporated by reference for all that it discloses. In some examples, the user information accessible through the remote device includes the user's age, gender, body composition, height, weight, health conditions, other types of information, or combinations thereof.

The processing resources, memory resources, and remote devices may communicate over any appropriate network and/or protocol through the input/output resources. In some examples, the input/output resources includes a transmitter, a receiver, a transceiver, or another communication device for wired and/or wireless communications. For example, these devices may be capable of communicating using the ZigBee protocol, Z-Wave protocol, BlueTooth protocol, Wi-Fi protocol, Global System for Mobile Communications (GSM) standard, another standard, or combinations thereof. In other examples, the user can directly input some information into the tracking system through a digital input/output mechanism, a mechanical input/output mechanism, another type of mechanism, or combinations thereof.

The memory resources may include a computer readable storage medium that contains computer readable program code to cause tasks to be executed by the processing resources. The computer readable storage medium may be a tangible and/or non-transitory storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, magnetic based memory, other types of memory, or combinations thereof.

The memory resources may include a bite counter that represents programmed instructions that, when executed, cause the processing resources to count the number of bites taken by a user. Each bite may include a mouthful of food. For example, a spoonful of food may be considered to be a single bite. The chew counter may represent programmed instructions that, when executed, cause the processing resources to count the number of chews executed by the user. In some circumstances, the number of chews is tracked per bite. In other examples, the number of chews is tracked for an entire meal, or just a portion of the meal. In some examples, the tracking system may include a swallow counter. In those examples that include a swallow counter, the number of shallows may be counted. A shallow may be determined by a pause in chewing, the detection of sounds indicative of swallowing, movements indicative of swallowing, other types of conditions, or combinations thereof.

Based on the chewing, swallowing, and biting data collected by the sensor, other types of information may be determined. For example, the tracking system may include a chew speed determiner that represents programmed instructions that, when executed, cause the processing resources to determine how fast the user is eating/chewing. This information may be helpful for a user to know so that the user can slow down in circumstances where the user is eating at a rate that is suboptimal. In some cases, eating too fast may result in the user eating more than is ideal. In response, the tracking system may recommend to the user that he or she to slow down.

Other information that may be determined from the data collected with the sensor includes a calorie estimate. In some examples, the memory resources includes a calorie estimator, which represents programmed instructions that, when executed, cause the processing resources to estimate the number of calories that the user has eaten. The number of calories may be estimated based on an assumed average number of calorie per bite.

The tracking system may also include a chewing analyzer, which represents programmed instructions that, when executed, cause the processing resources to analyze the characteristics of the user's chewing. In some cases, the chewing analyzer determines attributes about the food based on the user's chewing. For example, the chewing analyzer may determine that the food is chewy, soft, liquidy, tough, brittle, and so forth, based on the sounds and movements of the user's chewing. This information may help the tracking system determine the type of food that the user is eating. The food type determiner may use the information from the chewing analyzer to determine the food type. Knowing the food type may allow the tracking system to refine the calorie estimate. In other examples, knowing the food type may refine the messages that the user receives from the tracking system. For example, the tracking system may recommend that the user that the user execute even more chews when it is determined that the food has a chewy consistency.

The food type determiner may be associated with a calorie/food library that associates the food type with nutritional information by bite volume. The nutritional information may include calories, proteins, carbohydrates, fiber, cholesterol, sugars, fats, vitamins, minerals, iron, alcohol content, other types of nutritional information, or combinations thereof.

The calorie number determiner represents programmed instructions that, when executed, cause the processing resources to determine the calories in the food. In one example, the calorie calculator may consult the nutritional library and multiply the number of calories by the volume. In those examples where multiple types of foods are being weighed simultaneously, each of the calories for each of the food types may be measured separately and added together to determine the overall calorie amount.

The goal determiner represents programmed instructions that, when executed, cause the processing resources to determine the user's goals. In some examples, the goal determiner consults the user's personal profile to determine the user's goals. A calorie threshold determiner represents programmed instructions that, when executed, cause the processing resources to determine when the user is approaching a threshold for the number of calories that the user desires to eat in a meal, a day, or another time period. In some examples, the tracking system communicates to the user whether the user is on pace to reaching the calorie threshold. This may help the user pace himself or herself throughout the day so that the user is more likely to stay under his or her calorie goals.

The notification delivery may determine the appropriate type of message to deliver to the user based on the nutritional information associated with the collected chewing data. In some examples, the notification may be associated with the user's health goals. In other examples, the notification may be associated with a health risk, an allergy risk, another type of risk, another type of information, or combinations thereof.

The notification delivery may send notifications to the user through any appropriate mechanism. For example, the notification generator may cause an email, a text message, another type of written message, or combinations thereof to be sent to the user. In other examples, the notification generator may cause an audible message to be spoken to the user. In yet other examples, the notification generator may cause a vibration or another type of haptic event to occur to indicate to the user a notification related to the user's goal. Further, the notification may be presented to the user in the mobile device's screen.

While the examples above have been described with reference to determining a number of calories being consumed by the user, the principles above may be applied to determining other types of information about the food being consumed by the user. For example, the principles described in the present disclosure may be used to determine the amounts of protein, fat, salt, vitamins, fiber, other types constituents, or combinations thereof. The nutritional information may be reported to the user through the same or similar mechanisms used to report the calorie information to the user. The nutritional information may be ascertained through appropriate libraries that associate the food constituents with the food type per food volume. Further, the user may set goals pertaining to these other nutritional aspects as well. For example, the user may set goals to stay under a certain amount of salt or to consume at least a specific number of grams of protein in a day. The notification delivery may notify the user accordingly for these salt intake and protein consumption goals as described above.

Further, the memory resources may be part of an installation package. In response to installing the installation package, the programmed instructions of the memory resources may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources and the memory resources are located within the sensor, the mobile device, an external device, another type of device, or combinations thereof. The memory resources may be part of any of these device's main memory, caches, registers, non-volatile memory, or elsewhere in their memory hierarchy. Alternatively, the memory resources may be in communication with the processing resources over a network. Further, data structures, such as libraries or databases containing user and/or workout information, may be accessed from a remote location over a network connection while the programmed instructions are located locally. Thus, the tracking system may be implemented with the case, the sensor, the mobile device, a wearable computing device, a head mounted device, a server, a collection of servers, a networked device, a watch, or combinations thereof. The implementation may occur through input/output mechanisms, such as push buttons, touch screen buttons, voice commands, dials, levers, other types of input/output mechanisms, or combinations thereof. Any appropriate type of wearable device may include, but are not limited to glasses, arm bands, leg bands, torso bands, head bands, chest straps, wrist watches, belts, earrings, nose rings, other types of rings, necklaces, garment integrated devices, other types of devices, or combinations thereof.

In some examples, the wearable includes a head mounted portion, and the sensor is incorporated into the head mounted portion. The eyewear may be secured to the user's head at three locations, with a first earpiece hooked to a first ear, a second earpiece hooked to a second ear, and a bridge/nose pad that rests on the user's nose. At least one lens may be secured to a frame of the eyewear. In those examples where the wearable is eyewear, the head mounted portion may include one of the earpieces that hooks behind one of the user's ears. The earpiece may include a first portion of the eyewear's temple that rests on the top of the ear and a second portion that projects downward behind the back of the ear towards the user's jaw. The sensor may be attached to the second portion that projects downward. The sensor may be positioned proximate the user's jaw. In other examples, the sensor may be spaced a distance away from the user's jaw, but still within a range where sounds and/or movements from chewing can be detected.

In other examples, the eyewear is connected to the user's head through an band. In this example, the sensor may be connected to the band. Any appropriate type of eyewear may be used in conjunction with the principles described herein. For example, the eyewear may include sunglasses, prescription sunglasses, non-prescription sunglasses, goggles, other types of spectacles, or combinations thereof.

In those embodiments where the wearable is a hat, the hat can position the sensor adjacent to the user's temples. As the user eats, the user's temples move, which can be detected by the sensor. In some cases, the sensor is attached to the hat on the hat's inside surface. Such a sensor may be attached with Velcro, an adhesive, switching, magnets, another type of attachment, or combinations thereof. In yet other examples, the sensor is interwoven with the hat's fabric. Any appropriate type of sensor may be used. For example, the sensor may be an accelerometer, a strain gauge, an optical sensor, another type of sensor, or combinations thereof. In those examples where the sensor is a strain gauge, the strain gauge may measure a change in an electrical property in response to being stretched. This type of strain gauge may be a capacitive strain gauge, an inductive strain gauge, another type of strain gauge, or combinations thereof. As the user chews, his or her temples will move outward as the user's mandible moves with respect to the maxilla. The movement of the temples may stretch the portion of the hat to which the strain gauge is attached. In some examples, an entire bottom edge of the hat may stretch as the temples move. In this situation, the strain gauge may be placed along any portion of the hat's bottom edge. But, in some embodiments, the strain gauge is attached adjacent to the hat's bottom edge and proximate at least one of the user's temples.

In those examples where the sensor includes an accelerometer, the accelerometer may also be attached proximate to the temples. This accelerometer may be attached to the inside of the hat or woven into the hat's fabric. In those examples where the hat is made of a stiff material, the accelerometer may be attached to the hat on the hat's outside or attached at a location remote to the user's temples.

Any appropriate type of hat may be used in accordance with the principles described in the present disclosure. A non-exhaustive list of hats that may be compatible with the principles described herein include a wool hat, a beanie, a cowboy hat, a baseball cap, a wide brimmed hat, a brimmed hat, a beret, a bucket hat, a hat with ear flaps, a helmet, a fedora, a hard hat, a party hat, a sombrero, another type of hat, or combinations thereof. In those examples where the wearable is a hat, the sensor may include a microphone. In this example, the microphone may be positioned by the hat to be behind the user's ear or be within range of hearing the sounds generated by the user's chewing.

In those examples where the wearable is a necklace, the sensor may be placed along any appropriate portion of the necklace. In some examples, the sensor is positioned by the necklace to be proximate the user's jaw, laryngeal prominence (i.e. Adam's apple), neck, or other body part that moves as the user chews. In these examples, the sensor may be a strain gauge or an accelerometer that detects the movements of these respective body parts. In yet other examples, the sensor may be a microphone that detects the sounds generated by the movement of these parts during chewing.

Any appropriate type of garment may be the wearable. In one example, the garment is a scarf that can position the sensor to be proximate the user's jaw, laryngeal prominence, neck, or other body part. In these examples, the sensor may be attached to the inside of the garment, the outside of the garment, woven into the garment's fabric, or otherwise attached to the garment. In some examples, the garment may be a shirt or jacket with a high neck or collar. In these examples, the high neck and/or collar may position the sensor.

What is claimed is:

1. An eating feedback system, comprising:
a wearable;
a sensor connected to the wearable;
a memory and processor, the memory including programmed instructions to cause the processor to:
count a chew number executed by a user based on measurements recorded with the sensor; and
communicate feedback to the user based on the chew number.

2. The eating feedback system of claim 1, wherein the feedback includes a command to execute additional chews.

3. The eating feedback system of claim 1, wherein communicating feedback to the user based on the chew number occurs when the chew number falls below a predetermined chew threshold.

4. The eating feedback system of claim 1, further including:
a speaker;
wherein communicating the feedback includes generating an audible command with the speaker.

5. The eating feedback system of claim 1, wherein the wearable includes a hat.

6. The eating feedback system of claim 1, wherein the wearable includes eye ware.

7. The eating feedback system of claim 1, wherein the wearable includes neck apparel.

8. The eating feedback system of claim 1, wherein the sensor includes a microphone.

9. The eating feedback system of claim 1, wherein the sensor comes into mechanical contact with a jaw of the user when the wearable is worn by the user while the user is chewing.

10. The eating feedback system of claim 1, wherein the programmed instructions further cause the processor to determine a bite number based on at least one chewing attribute.

11. The eating feedback system of claim 10, wherein the programmed instructions further cause the processor to determine a calorie number based on the bite number.

12. The eating feedback system of claim 10, wherein the programmed instructions further cause the processor to determine an eating rate based on the at least one chewing attribute.

13. The eating feedback system of claim 12, wherein the programmed instructions further cause the processor to generate a message to the user based on the eating rate.

14. The eating feedback system of claim 1, wherein the sensor comprises an audio detection component that detects vocalization of the user;
wherein the sensor stops incrementing counts when detecting a vocalization of the user.

15. The eating feedback system of claim 1, further comprising an activation component that, when activated, causes the programmed instructions to initiate counting.

16. The eating feedback system of claim 1, wherein the sensor is in communication with a remote device;
wherein the sensor sends recorded chewing data to the remote device.

17. An eating feedback system, comprising:
a wearable;
a sensor connected to the wearable;
a memory and processor, the memory including programmed instructions to cause the processor to:
detect at least one chewing attribute based on measurements recorded with the sensor; and
determine a bite number based on the at least one chewing attribute.

18. The eating feedback system of claim 14, wherein the programmed instructions further cause the processor to determine an eating rate based on the at least one chewing attribute.

19. The eating feedback system of claim 14, wherein the programmed instructions further cause the processor to count a chew number executed by a user based on measurements recorded with the sensor and communicate feedback to the user based on the chew number.

20. A wearable device, comprising:
a head attachment portion;
a sensor connected to the head attachment portion;
a memory and processor, the memory including programmed instructions to cause the processor to:
count a chew number executed by a user based on measurements recorded with the sensor;
communicate feedback to the user based on the chew number;
determine a bite number based on at least one chewing attribute;
determine a calorie number based on the bite number;
determine an eating rate based on the at least one chewing attribute; and
generate a message to the user based on the eating rate.
